(19) United States
(12) Patent Application Publication
(10) Pub. No.: US 2018/0055031 A1
(43) Pub. Date: Mar. 1, 2018

(54) FISHING SYSTEM

(71) Applicant: David E. Wachob, New Hope, PA (US)

(72) Inventor: David E. Wachob, New Hope, PA (US)

(21) Appl. No.: 15/686,750

(22) Filed: Aug. 25, 2017

Related U.S. Application Data
(60) Provisional application No. 62/494,913, filed on Aug. 25, 2016.
(60) Provisional application No. 62/600,484, filed on Feb. 22, 2017.

(51) Int. Cl. A01K 97/12; A01K 89/027; A01K 87/00; A01K 85/01; A01K 97/24; A01K 91/20; G02B 6/38; H04N 7/22

(52) U.S. Cl. CPC A01K 97/125; A01K 89/03; A01K 87/007; A01K 85/01; H05B 37/0272; A01K 91/20; G02B 6/3887; H04N 7/22; A01K 97/24

(57) ABSTRACT

In one embodiment, an intelligent fishing system is provided to enable more accurate fishing in different water types and conditions. The system includes a fishing rod having a reel, the reel comprising at least a portion of a fiber optic cable, and a first device connected at or near a first end of the fiber optic cable, the first device having a controller and at least one camera. The system further includes a fiber optic receiver located at or near the fishing rod, the fiber optic receiver coupled to a second end the fiber optic cable and configured to receive optical signals from the first device through the fiber optic cable. Further, the system includes and a processor operably coupled to the fiber optic receiver and to a display.

### CROSS REFERENCE TO RELATED APPLICATIONS

The present application claims the benefit of U.S. Provisional Patent Application No. 62/494,913 filed Aug. 25, 2016, and U.S. Provisional Patent Application No. 62/600,484 filed Feb. 22, 2017. The disclosures of the aforementioned priority applications are incorporated herein by reference in their entirety.

### BACKGROUND OF THE INVENTION

Today's sport and commercial fishermen often fish blindly, with limited technology to ascertain the fishing conditions under the water. At best, sonar can be employed to determine the water's depth or possibly detect approximate schools of fish, depending upon their relative size, depth and motion. Other means include historical results by location, word of mouth, and just plain luck.

### BRIEF SUMMARY OF THE INVENTION

An enhanced intelligent fishing system is provided to enable more accurate fishing in any kind of water types or conditions, for both sport and commercial fishermen. The underlying technology can also be deployed with kites to enhance and expand the experience of flying kites, or to provide underwater or above ground surveillance.

### BRIEF DESCRIPTIONS OF THE DRAWINGS

FIG. 1 is a schematic diagram of the Intelligent Fishing System;

FIG. 2 is a schematic diagram of the Intelligent Fishing Lure;

FIG. 3 is a schematic diagram of the Intelligent Fishing Rod/Reel;

FIG. 4 is a schematic diagram of an alternative embodiment of the Intelligent Fishing System employing electrical fishing line;

FIG. 5 is a schematic diagram of an alternative embodiment of the Intelligent Fishing Lure employing electrical fishing line;

FIG. 6 is a schematic diagram of an alternative embodiment of the Intelligent Fishing Rod/Reel employing electrical fishing line;

FIG. 7 is a schematic diagram of an alternative embodiment of the Intelligent Fishing System employing mobile devices;

FIG. 8 is a schematic diagram of an alternative embodiment of the Intelligent Fishing Rod/Reel employing further functionality within the fishing rod/reel;

FIG. 9 is a schematic diagram of an alternative embodiment of the Intelligent Fishing Reel employing further functionality within the fishing reel;

FIG. 10 is a schematic diagram of an alternative embodiment of the Intelligent Fishing Reel employing further functionality within the fishing reel;

FIG. 11 is a schematic diagram of an alternative embodiment of the Intelligent Fishing Reel employing further functionality within the fishing reel;

FIG. 12 is a schematic diagram of an alternative embodiment of the Intelligent Fishing Reel employing further functionality within the fishing reel;

FIG. 13 is a schematic diagram of an alternative embodiment of the Intelligent Fishing Rod/Reel employing further functionality within the fishing reel;

FIG. 14 is a schematic diagram of an alternative embodiment of the Intelligent Fishing Reel employing further functionality within the fishing reel;

FIG. 15 is a schematic diagram of an alternative embodiment of the Intelligent Fishing Rod/Reel employing further functionality within the fishing reel;

FIG. 16 is a schematic diagram of an alternative embodiment of the Intelligent Fishing Lure with Fish Hook Release;

FIG. 17 is a schematic diagram of the Fish Hook Release;

FIG. 18 is a schematic diagram of the Intelligent Kite Monitor System.

### DETAILED DESCRIPTION OF THE INVENTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true. Furthermore, as used herein, the phrase “based on” is to be interpreted as meaning “based at least in part on,” and therefore is not limited to an interpretation of “based entirely on.”

The proposed inventions provide for, among other things, an indication of the fishing conditions on or under water directly at and/or around the site of where the fishing is to occur. More specifically, the inventions provide an indication of the fishing conditions at and/or around the fishing lure(s). The possible condition(s) which can be measured and/or indicated with the proposed invention include, but are not limited to, visual indication(s) such as still or video images (of the fish or otherwise), temperature indication(s), pressure indication(s), depth indication(s), clarity indication(s), lighting condition(s), salinity, sounds, location information, the presence of potential food source(s) or predators of the target fish to be caught, sounds or other measurable parameters. In one potential embodiment, the system, means and/or methods for measuring one or more of the above conditions are included within or as part of the fishing lure itself.

One embodiment of the proposed inventions leverages the information carrying capabilities of fiber optic strand and/or fiber optic cable, and the fact that fiber optic strand and/or cable has very similar characteristics to conventional fishing line. These characteristics include low visibility to the fish, high tensile and breaking strength for a given diameter, the ability to be spooled and unspooled, and relative affordability.

FIG. 1 provides an overview of the main components of one such embodiment of the invention. Contained within the Intelligent Fishing System 100 are the Intelligent Fishing Rod/Reel 101, the Fiber Optic Fishing Line 102, and the Intelligent Fishing Lure 103. Each of the main components will be indicated in more detail below.

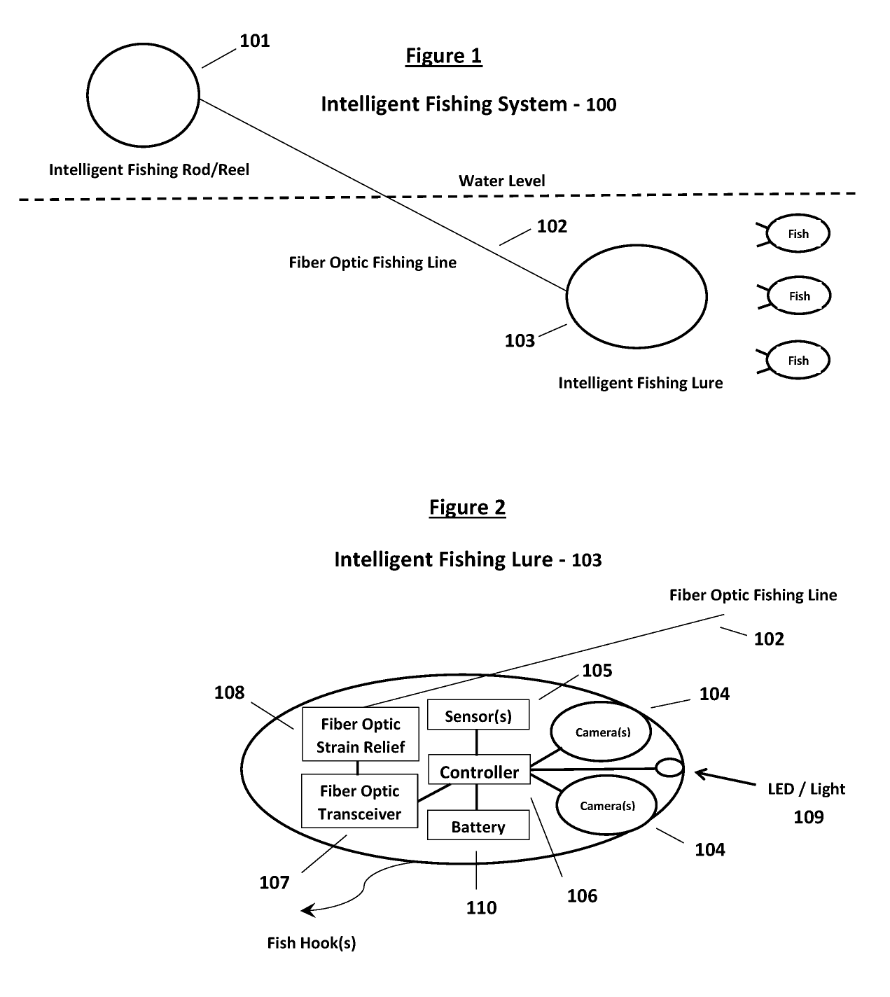

FIG. 2 details the Intelligent Fishing Lure 103, or first device of this one embodiment of the Intelligent Fishing System. This Intelligent Fishing Lure 103, located remote from the Intelligent Fishing Rod/Reel 101, includes several components, including one of more Camera(s) 104, potentially one or more Sensor(s) 105, one of more Controller(s) 106, one or more Fiber Optic Transceiver(s) 107, or alternatively, Fiber Optic Transmitter, one or more Fiber Optic Strain Relief Mechanism 108 (interfacing to the Fiber Optic Fishing Line 102, as indicated), one or more optional LED(s) or Light(s) 109, and one or more Battery(s) 110 to power the Lure. The LED(s) or Light(s) 109, or illumination sources, provide for illumination at or around the Camera(s) 104 of the Intelligent Fishing Lure 103, with illumination which originates from the Intelligent Fishing Lure 103. The Battery(s) 110 could be rechargeable or non-rechargeable. Inductive charging of the Battery(s) 110 is but one potential means to charge the Battery(s) 110, to minimize any potential water leakage into the Intelligent Fishing Lure 103. Alternatively, power could be provided from the Intelligent Fishing Rod/Reel 101 to the Intelligent Fishing Lure 103 in association with the Fiber Optic Fishing Line 102 via separate metallic conductor(s) (not shown in FIG. 2, but described later).

The Intelligent Fishing Lure 103 could potentially also include memory (not shown), separately or as included with one or more of the Controller(s) 106. The Intelligent Fishing Lure 103 might also optionally include a weight (not shown), made out of a wide variety of sizes, shapes and materials to ensure that the Intelligent Fishing Lure 103 can be potentially submersed.

In one such embodiment of the invention, one or more of the Camera(s) 104 in the Intelligent Fishing Lure 103 are recording real-time images (still and/or video) at the fishing location, to determine the presence of any fish at or near the Lure 103, or any other such conditions (such as predators, partners or food of the fish, or other environmental condition(s), such as landscapes, vegetation, lighting, water clarity, etc., etc.). The output(s) of the Camera(s) 104 are sent to the Controller 106 of FIG. 2 for processing as may be required or desired.

Processing of the images could facilitate display of the images on the Display (conventional or touch screen) associated with the Intelligent Fishing Rod/Reel 101 (explained below) and/or storage of those pictures in memory in the Intelligent Fishing Lure 103 and/or within memory present in any other part of the Intelligent Fishing System 100. The images, captured randomly, periodically, continuously, or “on demand” could be viewed in real time or non-real time. Additionally, the images could be stored and/or processed remotely from the Intelligent Fishing System 100.

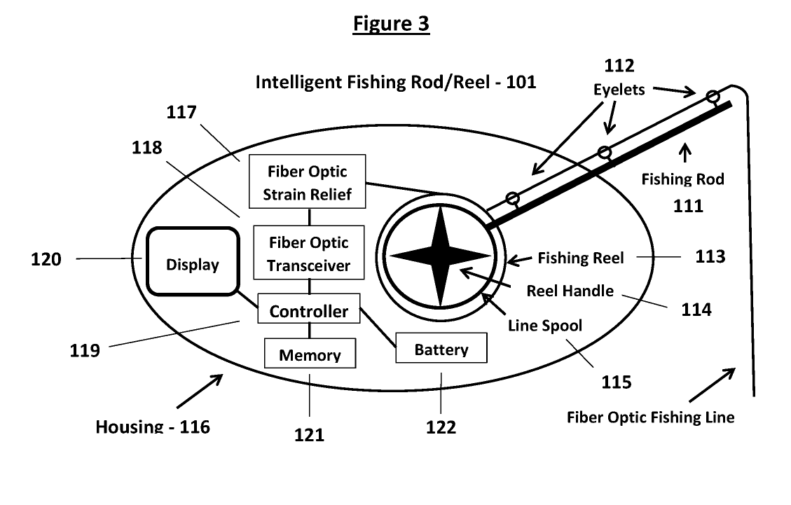

FIG. 3 highlights in more detail one embodiment of the Intelligent Fishing Rod/Reel 101. Included in the Intelligent Fishing Rod/Reel 101 is a Fishing Rod 111 potentially with one or more Eyelets 112 as noted, for ensuring proper alignment and management of the Fiber Optic Fishing Line 102, as the Fiber Optic Fishing Line 102 is deployed into the water and/or spooled back onto the Fishing Reel 113. The Fishing Reel 113 could also potentially includes a Reel Handle 114 as indicated, as a mechanism for spooling the Fiber Optic Fishing Line 102 back onto the Fishing Reel 113 after it has been deployed into the water. The Fiber Optic Fishing Line 102 is wound (spooled) upon the Line Spool 115 in FIG. 3 when not deployed, including excess Fiber Optic Fishing Line 102 as may be required for future deployment. This Line Spool 115 may need to be of a larger diameter compared to the spool of a conventional (non-Fiber Optic) fishing reel, to ensure that the Fiber Optic Fishing Line 102 is not damaged during spooling onto the Line Spool 115. Additionally, even though FIG. 3 indicates a specific orientation of the Line Spool 115 relative to the Fishing Reel 113 and/or the Fishing Rod 111, this Line Spool 115 may also be oriented in other positions and/or planes relative to the Fishing Reel 113 and/or Fishing Rod 111. A Housing 116 is also provided, as included in FIG. 3.

Also included in FIG. 3 is the Fiber Optic Strain Relief 117, which absorbs the strain that may be present on the Fiber Optic Fishing Line 102 at any time, to prevent damage to or breakage of the Fiber Optic Fishing Line 102, or detachment of the Fiber Optic Fishing Line 102 from either the Intelligent Fishing Lure 103 or the Intelligent Fishing Rod/Reel 101. The Fiber Optic Strain Relief 117 is optically coupled to the Fiber Optic Transceiver 118, or alternatively, Fiber Optic Receiver, in FIG. 3 by the same Fiber Optic Fishing Line 102 or otherwise, which in turn converts the optical signals received from one or more of the Fiber Optic Transceiver(s) 107 in the Intelligent Fishing Lure 103 of FIG. 2, into electrical signals. The electrical signals are then coupled to the Controller 119, or alternatively, processor in the Intelligent Fishing Rod/Reel 101 as indicated, for processing and display on the Display 120 (conventional or touch screen), storage in the Memory 121, or both. If the Display 120 is a touch screen, then signals sent from the Display 120 to the Controller 119 can be used to control functionality within the Intelligent Fishing Rod/Reel 101, remotely within the Intelligent Fishing Lure 103, or both. Battery(s) 122 is also indicated in FIG. 3, either non-chargeable or re-chargeable, to provide power to the Intelligent Fishing Rod/Reel 101.

The Fiber Optic Strain Reliefs 108 or 117 of both the Intelligent Fishing Lure 103 (FIG. 2) and the Intelligent Fishing Rod/Reel 101 (FIG. 3) are provided to minimize the possibility of the Fiber Optic Fishing Line 102 from becoming damaged and/or detached from either the Intelligent Fishing Lure 103 or the Intelligent Fishing Rod/Reel 101. A wide variety of strain reliefs mechanisms are possible for either or both the above strain reliefs, to prevent the possibility of the Fiber Optic Fishing Line 102 from becoming damaged and/or detached from either the Intelligent Fishing Lure 103 or the Intelligent Fishing Rod/Reel 101, including, but not limited to, chemical/adhesive strain reliefs, mechanical strain reliefs, etc. By way of example, one of many such chemical/adhesive strain relief mechanisms could be facilitated with an epoxy resin, which adheres both to the Fiber Optic Fishing Line 102 and/or its protective coating, and the enclosures and/or internal components of the Fiber Optic Strain Reliefs 108 or 117 or the Intelligent Fishing Lure 103, and similarly at the Intelligent Fishing Rod/Reel 101. One of many possible mechanical strain reliefs could include a spring type mechanism, to allow the Fiber Optic Fishing Line 102 and/or the Fiber Optic Strain Reliefs 108 or 117 to “stretch” under a prescribed pull force present. Variations on the above are also possible that could include both an epoxy resin and a spring type mechanism, etc., on one or both strain reliefs 108 or 117 at either the Intelligent Fishing Lure 103 and/or the Intelligent Fishing Rod/Reel 101, to provide the Fiber Optic Fishing Line 102 both mechanical support and the ability to stretch under a pull force present.

The Fiber Optic Strain Relief(s) 108 or 117 could also include component(s) of the Fiber Optic Transceivers 107 or 118, or alternatively, Fiber Optic Transmitter or Fiber Optic Receiver, respectively, to further minimize any potential damage to or detachment of the Fiber Optic Fishing Line 102. One such example of this would be to include the fiber optic diode, typically included in the Fiber Optic Transceivers 107 or 118, within the Fiber Optic Strain Reliefs 108 or 117 instead. Since the fiber optic diode interfaces directly with Fiber Optic Fishing Line 102, including one or both of the fiber optic diodes as part of the Fiber Optic Strain Relief Mechanisms 108 or 117 could minimize the likelihood of the fiber optic diode from separating from the Fiber Optic Fishing Line 102 when a predetermined pull force is present on the Fiber Optic Fishing Line 102, either at the Intelligent Fishing Lure 103 and/or the Intelligent Fishing Rod/Reel 101. Encasing one or both the fiber optic diodes and the Fiber Optic Fishing Line 102 in epoxy resin is but one example of combining the fiber optic diode within the Fiber Optic Strain Reliefs 108 or 117. In these embodiments, the fiber optic diode(s), is now configured as part of the Fiber Optic Strain Reliefs 108 or 117, and is now electrically rather than optically connected to the Fiber Optic Transceivers 107 or 118, which no longer contains the fiber optic diode(s). As such, the Fiber Optic Transceiver 107 or 118 (or Fiber Optic Transmitter or Receiver, respectively) now becomes a transmitter or receiver, respectively.

The Fiber Optic Fishing Line 102 included in FIGS. 1, 2 and 3 is similar if not identical to fiber optic strand or fiber optic cable, used in telecommunications systems to transport information. As such, it is able to transport optical signals at baseband or one or more wavelengths, to facilitate one or two way communications between the Intelligent Fishing Lure 103 and the Intelligent Fishing Rod/Reel 101. The Fiber Optic Fishing Line 102 may be composed of a single strand of fiber optic cable or multiple strands of fiber optic cable. This strand or strands might also be encased in a protective coating, casing or otherwise to provide additional mechanical shielding and strength to the Fiber Optic Fishing Line 102.

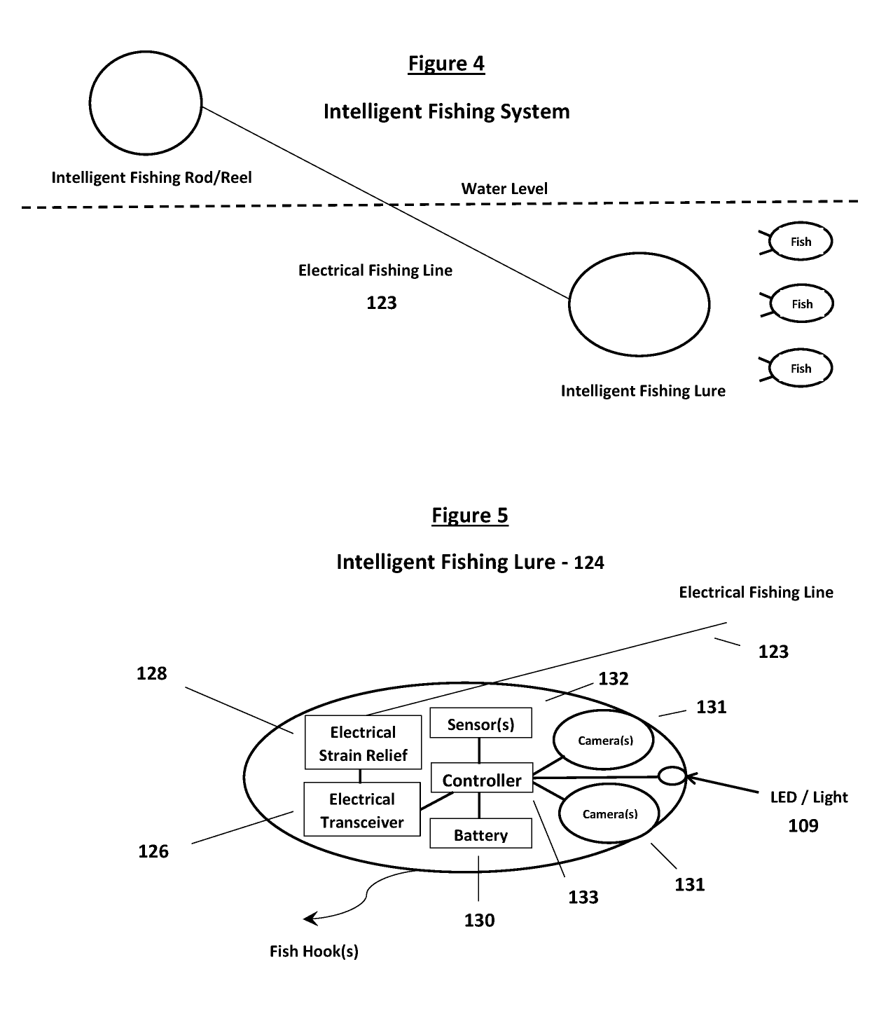

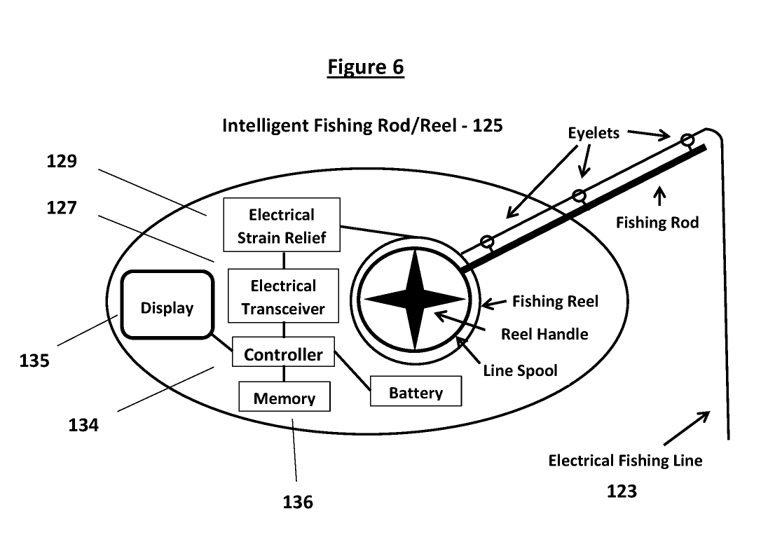

Alternatively, conventional metallic conductors could be used in lieu of the Fiber Optic Fishing Line 102, to facilitate communication between the Intelligent Fishing Lure 103 and the Intelligent Fishing Rod/Reel 101. In such an alternate embodiment, electrical signals rather than optical signals would be communicated on the Electrical Fishing Line 123 in FIG. 4, FIG. 5 and FIG. 6 between the Intelligent Fishing Lure 124 and the Intelligent Fishing Rod/Reel 125, as either baseband or modulated RF signals. One or more metallic conductors would need to be provided for the Electrical Fishing Line 123. These one or more electrical conductors could be also used as the fishing line itself between the Intelligent Fishing Lure 124 and the Intelligent Fishing Rod/Reel 125, or the one or more metallic conductors could be included with a supplemental fishing line, such as conventional (nylon or otherwise) fishing line, as one such example. Any number of ways could be used to integrate the one or more metallic conductors (or the one or more metallic conductors with the conventional fishing line) together, such twisting, laminating, or adhering, etc. them together. Additionally, the combined conventional fishing line and/or one or more metallic conductors could potentially also be encased or enclosed within a protective jacket (not shown), made out of a wide variety of potential materials, including but not limited to, plastic, metal, rubber, nylon, fabric, etc.

One or more Electrical Transceivers 126 or 127 rather than Fiber Optic Transceivers 107 or 118 would then be required in both the Intelligent Fishing Lure 124 and the Intelligent Fishing Rod/Reel 125. Electrical Strain Reliefs 128 or 129 in either or both the Intelligent Fishing Lure 124 and Intelligent Fishing Rod/Reel 125 may also be required, similar to or different from the Fiber Optic Strain Reliefs 108 or 117, to prevent the Intelligent Fishing Line 123 from becoming detached from either the Intelligent Fishing Lure 124 or the Intelligent Fishing Rod/Reel 125. FIGS. 4, 5 and 6 provide more detail of this alternative embodiment.

In addition to communicating the information (images or otherwise) between the Intelligent Fishing Lure 124 and the Intelligent Fishing Rod/Reel 125, the above one or more metallic conductors could also be used to transport powering from the Intelligent Fishing Rod/Reel 125 to the Intelligent Fishing Lure 124. This powering could be provided in the form of a DC or low frequency AC voltage.

If powering is also provided on the one or more metallic conductors, the Electrical Transceiver 126 in the Intelligent Fishing Lure 124 of FIG. 5 would also need to include circuitry (not shown) to remove the DC or low frequency AC voltage from the metallic conductor(s) to provide power to the Intelligent Fishing Lure 124. In this embodiment, the Battery 130 in FIG. 5 could also be removed, or if rechargeable, could remain and be charged by the above DC or low frequency AC voltage. Likewise, the Electrical Transceiver 127 in the Intelligent Fishing Rod/Reel 125 of FIG. 6 would also need to include circuitry to add the DC or low frequency AC voltage onto one or more metallic conductor(s), if powering is to be provided on the metallic conductors (not shown).

Similar changes to the Optical Transceivers 107 or 118 in both the Intelligent Fishing Lure 103 in FIG. 2 and Intelligent Fishing Rod/Reel 101 in FIG. 3 would also be needed (not shown), if powering is provided by one or more metallic conductor(s) in association with the Fiber Optic Fishing Line 102, as described previously.

Processing of the above images could include processing for simple display of the images in real-time for display to the person fishing, on the Display 120 of the Intelligent Fishing Rod/Reel 101 and/or storage of these images, either within the Intelligent Fishing Lure 103, and/or the Intelligent Fishing Rod/Reel 101, and/or external to the system. If more than one Cameras 104 or 131 are present within the Intelligent Fishing Lures 103 of FIG. 2 or FIG. 5, processing of the images from the multiple cameras could provide a stereoscopic composite of the image(s), to provide a “3-D” or more complete view from the Intelligent Fishing Lure 103 or 124 and/or a front, back, top, bottom, or side view(s) from the Intelligent Fishing Lure 103 or 124, or any variation thereof. Alternatively, a single camera with a “fish eye” type lens could be utilized to provide a panoramic image from said single camera. The processing and/or storage of any of the images could be done at the Intelligent Fishing Lure 103 or 124 and/or within the Intelligent Fishing Rod/Reel 101 or 125 and/or external to the system, in real-time or non real-time.

The above image information could be supplemented with additional information, as provided by one or more Sensor(s) 105 or 132 within the Intelligent Fishing Lures 103 or 124 in FIG. 2 or FIG. 5. This additional information could include temperature indication(s), pressure indication(s), depth indication(s), acceleration force, tension on the Intelligent Fishing Line, salinity, clarity indication(s), lighting conditions, location information, the presence of potential food source(s) or predators of the fish to be caught, sounds, time and date information, power remaining in the Battery 110 or 130 or other measurable parameters by the Sensor(s) 105 or 132. This information could be captured randomly, periodically, continuously, or “on demand” by the fisherman or fisherwoman, and provided in real-time or non real-time. Information from any or all of the additional Sensor(s) 105 or 132, either separately or in addition to the image information, provides for a more complete indication of the area at and around the Intelligent Fishing Lures 103 or 125.

The additional information received from the additional Sensor(s) 105 or 132, either individually or combined, is also processed by the Controller(s) 105 or 133 in the Intelligent Fishing Lures of FIG. 2 or FIG. 5 and communicated to the Intelligent Fishing Rod/Reel 101 or 125 by its Transceiver(s) 118 or 127, then via the Fiber Optic or Intelligent Fishing Line 102 or 123 to the Transceiver 118 or 127, or alternatively, Receiver in the Intelligent Fishing Rod/Reel 101 or 125 in FIG. 3 or FIG. 6. The Transceiver(s) 118 or 127 within the Intelligent Fishing Rod/Reel 101 or 125 then interfaces electrically with the Controller(s) 119 or 134, to process and display the additional information on the Display 120 or 135 within the Intelligent Fishing Rod/Reel 101 or 125 and/or store the information in the Memory 121 or 136 or elsewhere.

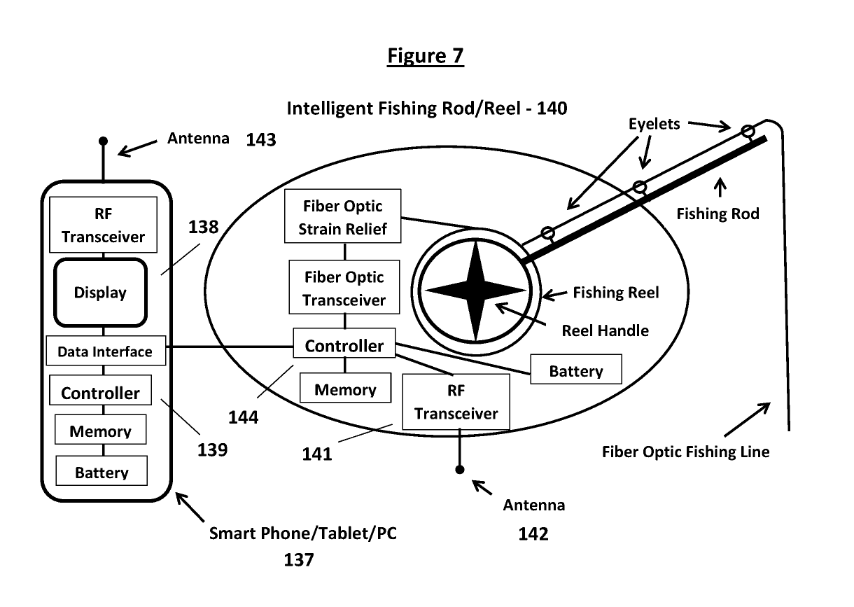

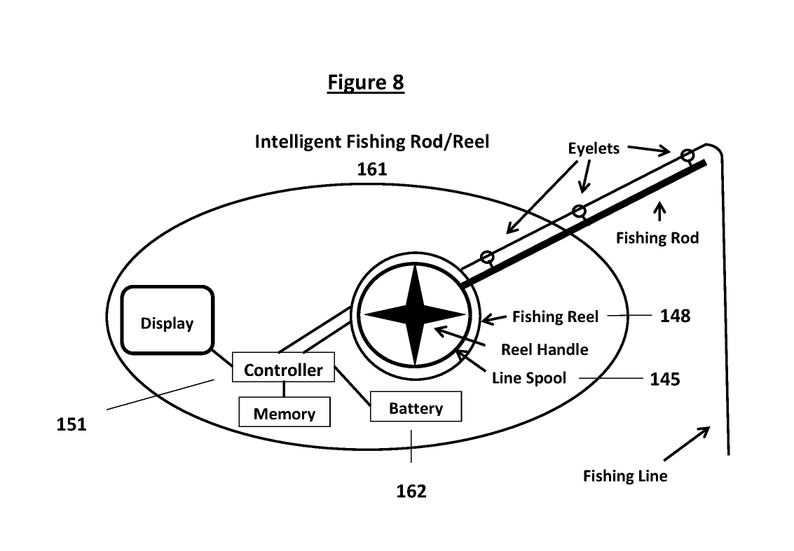

Another potential embodiment of the invention is illustrated in FIG. 7, which provides an alternative display and/or processor, for displaying and/or processing the above described information, via a mobile devices 137, such as Smart Phone, Tablet device, LapTop or other PC type device. This display 138 and/or processing 139 could be in lieu of the Display 120 or 135 and/or processing device(s) 119 or 134 in FIG. 3 or FIG. 6, or in addition to the Display 120 or 135 and/or processing device(s) 119 or 134 in FIG. 3 or FIG. 6. Data is transferred between the Intelligent Fishing Rod/Reel 140 and the Smart Phone, Tablet or PC 137 either by a physical connection as indicated in FIG. 7, using any number of physical data interfaces such as USB, FireWire, Lightning Connector, etc., and/or also wirelessly, via BlueTooth, WiFi, ZigBee, etc., the latter of which would also require BlueTooth, WiFi, ZigBee, etc. capabilities to be included in the Intelligent Fishing Rod/Reel 140, as indicated by the RF Transceiver 141 and Antenna 142 included with the Intelligent Fishing Rod/Reel 140 in FIG. 7. It should be noted that this RF Transceiver 141 and Antenna 142 could also be included in the Intelligent Fishing Rod/Reel 101 or 125 in FIG. 3 or FIG. 6, and could communicate information from the Intelligent Fishing Rod/Reel 101, 125 or 140 directly to a remote device, without the need for the Smart Phone, Tablet Device or PC type mobile device 137 of FIG. 7.

The Smart Phone, Tablet or PC 137 illustrated in FIG. 7 could also include an “Ap(lication)”, to allow functionality, control and processing of the Information received from the Intelligent Fishing Rod/Reel 140, such as image processing, information storage, identification of fish types present at the Intelligent Fishing Lure 103 or 124, or analysis of all the information (visual, sensors, etc.) to also optionally provide additional information, including, but not limited to, the statistical probabilities of the likelihood of catching one or more types of fish at or around the Intelligent Fishing Lure 103 or 124. This and other functionality could be provided by the Smart Phone, Tablet or PC 137, by the Intelligent Fishing Rod/Reel 140, remotely by capabilities described below, or any combination thereof.

FIG. 7 also provides a means and method for communicating the information between the Intelligent Fishing Rod/Reel 140 (and Intelligent Fishing Lure 103 or 124) and a remote device (not shown) such as a server, website or any other device that the Smart Phone, Tablet or PC 137 can communicate with. This communication, both transmitting and receiving, can be facilitated by any of the inherent capabilities within the Smart Phone, Tablet or PC 137 such as cellular, WiFi, Bluetooth, etc., and its associated Antenna 143 as indicated. Some of the capabilities enabled by these remote devices could include image processing and/or streaming of the fishing locations, storage of the same and/or additional information from the Intelligent Fishing Lure 103 or 124 and/or Intelligent Fishing Rod/Reel 140, identification of fish types present at the Intelligent Fishing Lure 103 or 124, or analysis of all the information (visual, sensors, historical data, including but not limited to the results of the same or other fishermen, etc.) to provide historical data and/or the probability of catching one or more types of fish at or around the location of the Intelligent Fishing Lure 103 or 124, etc. This data could be processed by a processor 144 located within the Intelligent Fishing Rod/Reel 140, mobile device 137, remotely, or any combination thereof.

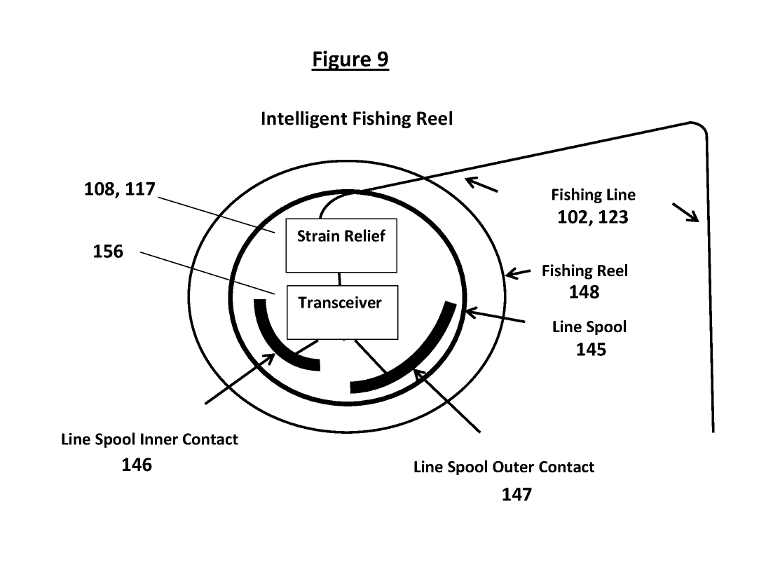

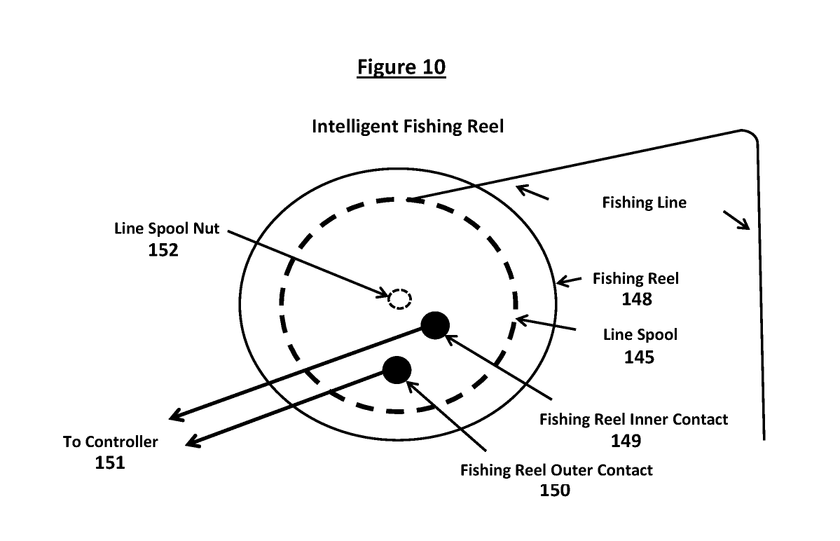

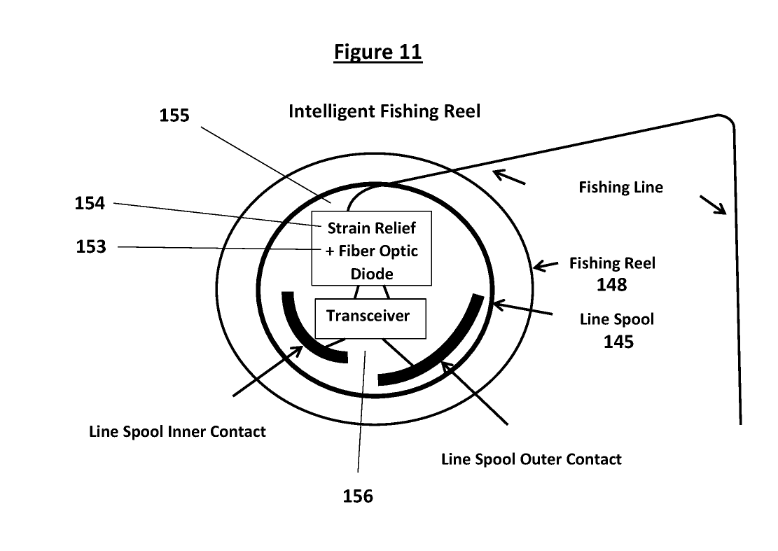

FIGS. 8, 9 and 10 detail further embodiments, for which Transceivers 118 or 127 (either Fiber Optic or Electrical) and/or the Strain Reliefs 108 or 117 (either Fiber Optic or Electrical) are contained within the Line Spool 145, onto which the Fishing Line 102 or 123 (either Fiber Optic or Electrical) is wound. Within the Line Spool 145, the Transceiver 156 is electrically connected to the Line Spool Inner Contact 146 and Line Spool Outer Contact 147 shown in FIG. 9. The Line Spool 145 is in turn connected to the Reel 148 by the Line Spool Inner and Outer Contacts 146, 147 of FIG. 9, which make mechanical and electrical contact to the Fishing Reel Inner Contact 149 and Fishing Reel Outer Contact 150 shown in FIG. 10. The Fishing Reel Inner and Outer Contacts 149, 150 of FIG. 10 are electrically connected to the Controller 151, shown in FIG. 8.

While the Line Spool Inner and Outer Contacts 146, 147 in FIG. 9 are shown as segments, they could also be segments of potentially bigger contacts, such as complete circles, as just one such example. The diameters of these circles are such that the Inner and Outer Contacts 146, 147 would not touch. FIG. 10 also includes a Line Spool Nut 152, which secures the Line Spool 145 within the Intelligent Fishing Reel 148.

The Fishing Reel Inner and Outer Contacts 149, 150 shown in FIG. 10 can implemented with a variety of techniques, such as metallic contacts positioned and/or bent so as to provide pressure against (and hence contact with) the Line Spool Inner and Outer Contacts 146, 147. Alternatively, the Fishing Reel Inner and Outer Contacts 149, 150 could be constructed out of graphite or other conductive materials, and connected mechanically and electrically to the Controller 151 in the Intelligent Fishing Rod/Reel 161 of FIG. 8. Whether the Fishing Reel Inner and Outer Contacts 149, 150 are constructed out of metal, graphite or an alternative material, they could potentially also include a spring type mechanism (a spring or otherwise) to provide pressure (and therefore mechanical and electrical contact) between the Fishing Reel Inner and Outer Contacts 149, 150 and the Line Spool Inner and Outer Contacts 146, 147.

It should also be noted that the implementation of the Fishing Reel Inner and Outer Contacts 149, 150 and the Line Spool Inner and Outer Contacts 146, 147 could be reversed. To further clarify, contacts similar or identical to Fishing Reel Inner and Outer Contacts 149, 150 described previously could be instead placed in the Line Spool 145, and contacts similar or identical to Line Spool Inner and Outer Contacts 146, 147 described previously could be instead placed in the Fishing Reel 148. The net result is the same, which is to provide mechanical and electrical contact between the Transceiver 156 of FIG. 9 and the Controller 151 of FIG. 8.

It should also be noted that in all prior drawings in this invention, interconnections between functional blocks have been generally illustrated as a single connection, although this is merely for convenience. For reference, most if not all of the illustrated connections in this invention will require one or more connections, to enable the functionality so required. This could be facilitated with a single connection, a single connection referenced to a ground reference level, or more than one single connections.

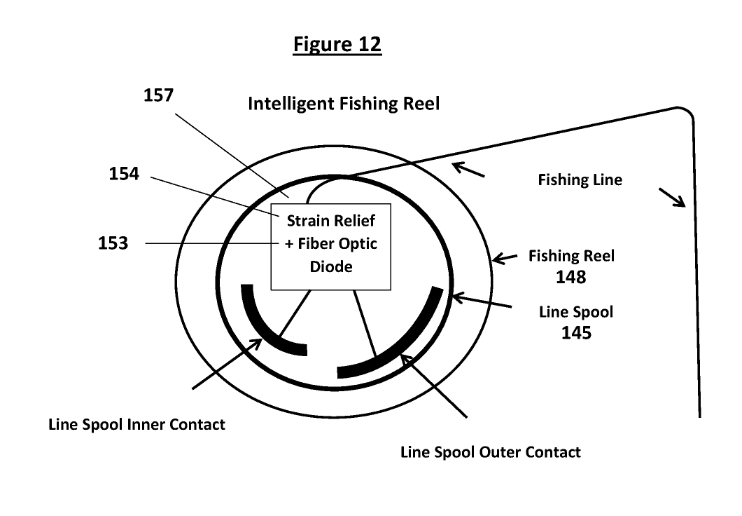

Additionally, as mentioned previously, one embodiment described provides for the Fiber Optic Strain Relief to instead also include components of the Fiber Optic Transceiver, such as the fiber optic diode. This same capability is illustrated in FIG. 11, such that the Fiber Optic Diode 153 is included as part of the Strain Relief Mechanism 155, rather than the Transceiver (or Receiver) 156. In this case, there is an electrical connection between the Strain Relief Mechanism 155 and the Transceiver (or Receiver) 156, rather than an optical connection.

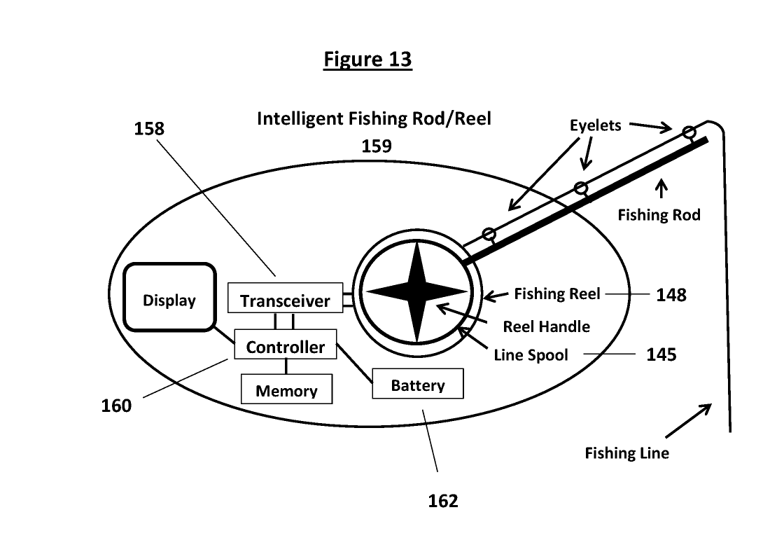

FIG. 12 details yet a further embodiment, which provides for just the Strain Relief 154 and the Fiber Optic Diode 153 to be included within the Strain Relief Mechanism 157 within the Line Spool 145. In this implementation, the Transceiver (or Receiver) 158, minus the Fiber Optic Diode 153 is now included in the Intelligent Fishing Rod/Reel 159 of FIG. 13, and electrically connected to both the Fishing Reel 148 and Controller 160.

Providing any of the above implementations in FIG. 8 through FIG. 13 allows the Line Spool 145 to potentially rotate circularly, and still maintain mechanical and electrical contact between the Line Spools 145 and Fishing Reels 148 of FIGS. 9, 10, 11 and 12, without requiring a hardwired coupling between the Transceiver 156 (or Receiver) and the processor. Any of the above detailed contact implementations also allow the Line Spool 145 to be inserted into the Intelligent Fishing Rod/Reel 161 or 159, without regard to any specific orientation between the two, even in the case when the Line Spool 145 does not rotate. As such, any of the above detailed contact implementations allow the Line Spool 145 to be easily interchanged in the Intelligent Fishing Rod/Reel 161 or 159.

In any of the embodiments illustrated in FIG. 8 through FIG. 13, powering for the circuitry in FIGS. 8 through 13 could be from the Battery 162 illustrated in FIG. 8 or FIG. 13, powering from a battery to be included in FIGS. 9, 11 and 12 (not indicated) or both. If a battery is not included in the Line Spool in FIGS. 9, 11 and 12 for powering, and instead powering is provided from the Battery 162 indicated in FIG. 8 or FIG. 13, then powering can be provided via the previously mentioned connections between the Controller 151 and the Fishing Reel 148 in FIG. 8 or the Transceiver (or Receiver) 158 and Fishing Reel 148 in FIG. 13 to the Line Spool 145, via the Fishing Reel Inner and Outer Contacts 149, 150, and the Line Spool Inner and Outer Contacts 146, 147.

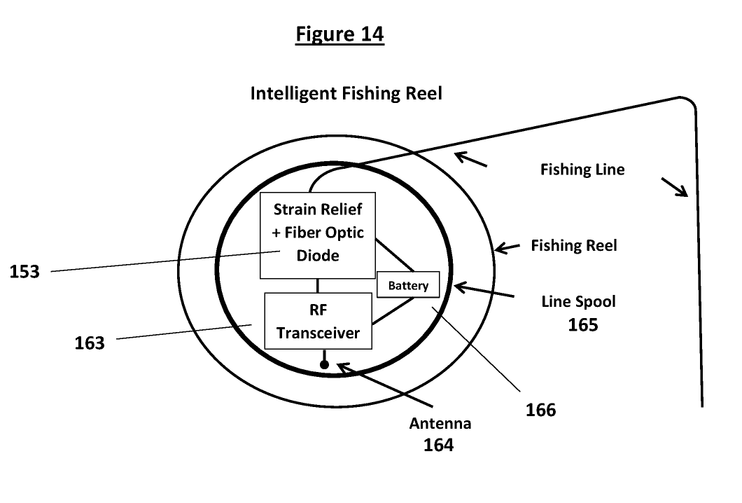

FIG. 14 provides another embodiment, which replaces the wired connection between the Line Spool and the Fishing Rod/Reel with a wireless connection. As such, it replaces the Line Spool Inner and Outer Contacts 146, 147 and the Fishing Reel Inner and Outer Contacts 149, 150 with an RF Transceiver 163 and Antenna 164 in the Line Spool 165 as indicated in FIG. 14. The RF Transceiver 163 could be operating in the WiFi, BlueTooth, ZigBee frequency bands or otherwise. Powering of the circuitry in the Line Spool 165 is provided by the Battery 166, as also indicated in FIG. 14.

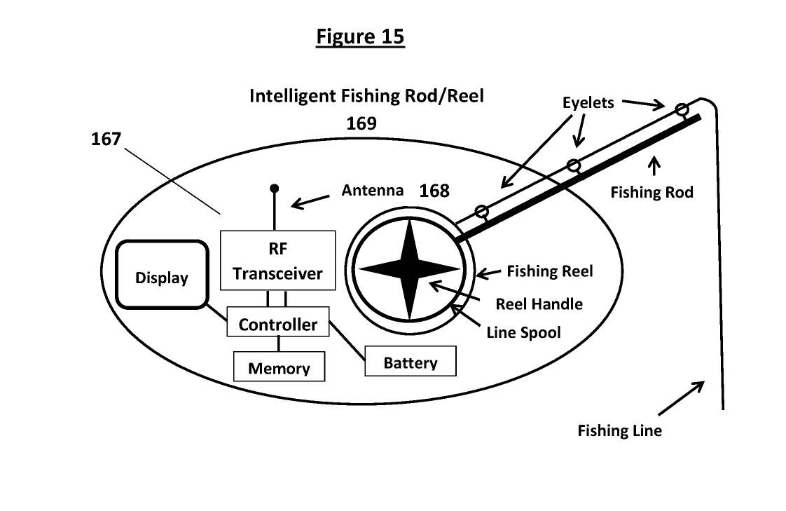

The RF Transceiver 163 and Antenna 164 in the Line Spool 165 in FIG. 14 would communicate wirelessly with the RF Transceiver 167 and Antenna 168 in the Intelligent Fishing Rod/Reel 169 in FIG. 15. The RF Transceiver 167 in the Intelligent Fishing Rod/Reel would be operating in the same WiFi, BlueTooth, ZigBee frequency bands or otherwise as in the RF Transceiver 163 in the Line Spool 165 of FIG. 14. Alternatively, the RF Transceiver 163 and Antenna 164 in the Line Spool 165 of FIG. 14 could communicate wirelessly with the Smart Phone, Tablet device or LapTop 137 in FIG. 7, and/or to a remote server via the WiFi, BlueTooth, ZigBee or cellular frequency bands via the Internet or otherwise. Also, the same approach described above (communicating directly with mobile device 137) could apply when the Fiber Optic Diode 153 is not included with the Fiber Optic Strain Relief 154, as described previously, such that the Fiber Optic Diode 153 is included as part of the RF Transceiver 163 (or Receiver) of FIG. 14.

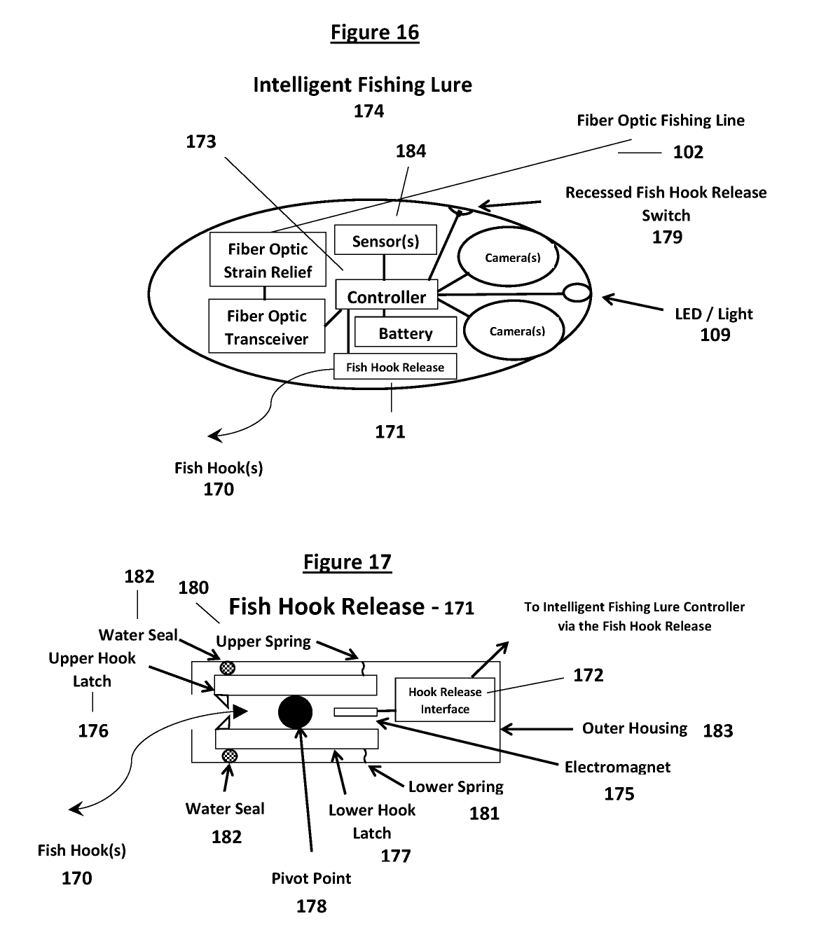

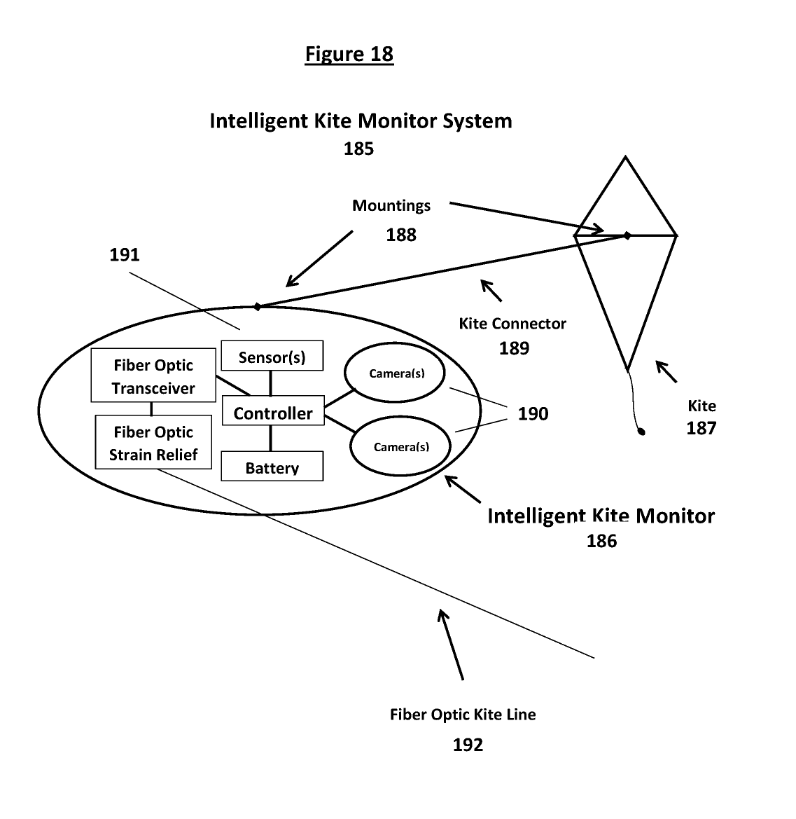

FIG. 16 and FIG. 17 provides for yet another embodiment of the invention, which allows for the Fish Hook(s) to be released from the Intelligent Fishing Lure. This embodiment could be desirable, if the Intelligent Fishing Lure with the Fish Hook(s) attached becomes snagged or entangled with any undesirable material including, but not limited to, plants, seaweed, rocks, branches, trash or any other such material which may be present under, on, or above the water, allowing the remainder of the Intelligent Fishing Lure (Intelligent Fishing Lure minus the Fish Hook(s)) to be recovered. It could also be desirable to release the Fish Hook if an undesirable fish or other aquatic life is caught or becomes attached to the Fish Hook, or it is not possible to catch a desired fish, by virtue of its size, strength, location, type and any other so desired reason. This release could be enabled under the direct control by the fisherman or fisherwoman, or whenever predefined conditions are detected within the Intelligent Fishing Lure, or both.

If the former, a control signal would be sent from the Intelligent Fishing Rod/Reel initiated by the fisherman or fisherwoman (via the Display 120, 135 or 138 or otherwise) which would be communicated via the Fiber Optic Fishing Line 102 or Electrical Fishing Line 123 from the Intelligent Fishing Rod/Reel 101, 125 or 140 to the Intelligent Fishing Lure 174. Such a command would be communicated via the Controllers and the Fiber Optic (or Electrical) Transceivers in both the Intelligent Fishing Rod/Reel 101, 125 or 140 and the Intelligent Fishing Lure 174. This command signal to activate the release the Fish Hook(s) 170 would then be communicated from the Controller 173 to the Fish Hook Release 171 in FIG. 16, also known as the Fish Hook Release Mechanism.

One such potential Fish Hook Release is further detailed in FIG. 17, including the Hook Release Interface 172, which is interfaced to the Controller 173 in the Intelligent Fishing Lure 174 as indicated in FIG. 16 and FIG. 17. Once the signal to release the Fish Hook(s) 170 is sent from the Fish Hook Release 171 in FIG. 16 and received by the Hook Release Interface 172 in FIG. 17, a signal is in turn communicated to the Electromagnet 175 in FIG. 17, to magnetize the Electromagnet 175. Once the Electromagnet 175 is magnetized, the Upper Hook Latch 176 and Lower Hook Latch 177 are pivoted around the Pivot Point 178, and their respective ends brought closer to the Electromagnet 175. This action in turn increases the gap between the Upper Hook Latch 176 and Lower Hook Latch 177, on the end opposite of the Electromagnet 175, allowing the Fish Hook(s) 170 to be released. The above embodiment requires either one or both of the Upper Hook Latch 176 and Lower Hook Latch 177 to be constructed at least partially out of ferrous metal, such that they are drawn towards the Electromagnet 175 when it is in the magnetized state.

Additionally, the Fish Hook(s) 170 could be optionally released manually, by pressing the Recessed Fish Hook Release Switch 179 included in the Intelligent Fishing Lure 174 in FIG. 16. Pushing this Recessed Release Switch 179 would send a signal to the Controller 173 in the Intelligent Fishing Lure 174 in FIG. 16, which would inturn send a signal to the Fish Hook Release 171 and Hook Release Interface 172 in FIGS. 16 and 17, respectively, and as described previously, to magnetize the Electromagnet 125. The switch is recessed, so that it does not accidentally get engaged (pushed) during normal use, so as to prematurely release the Fish Hook(s) 170.

The length of time that the Fish Hook Release 171 remains open, i.e., such that the Fish Hook(s) 170 can be detached from the Intelligent Fishing Lure 174 can be controlled by the fisherman or fisher woman, or automatically controlled by the Intelligent Fishing Rod/Reel or the Intelligent Fishing Lure, 174 or any combination thereof.

Upper Spring 180 and Lower Spring 181 are also included in FIG. 17, and attached to both (or either) of the Upper Hook Latch 176 and Lower Hook Latch 177, such that they cause the Fish Hook Release 171 to remain normally closed (i.e., the Fish Hook(s) 170 not able to be removed) when the Electromagnet 175 is not magnetized. Having such spring(s) 180 and 181 would also facilitate insertion of the Fish Hook(s) 170 into the Fish Hook Release 171, by virtue of the tapered shape of the Fish Hook(s) 170 inserted into the Fish Hook Release 171 and the tapered ends of the Upper Hook Latch 176 and Lower Hook Latch 177, as also so indicated in FIG. 17. As such, the Fish Hook(s) 170 to be used in association with this embodiment of the invention would likely need to be customized accordingly, although potentially some current Fish Hook(s) might be useable.

Also indicated in FIG. 17 are one or more Water Seal(s) 182, between the Fish Hook Release Outer Housing 183, and the Upper Hook Latch 176 and Lower Hook Latch 177. The purpose of the Water Seal(s) 182 is to keep the surrounding water and/or other moisture apart from the Hook Release Interface 172 and/or the Electromagnet 175 within the Fish Hook Release 171, when the Intelligent Fishing Lure 174 is on or submerged in water or other liquids. As such, the Water Seal(s) 182 would be made out of any number of pliable materials, sealants, gaskets, O-rings or the like that would maintain a water tight seal between the Fish Hook Release Outer Housing 183, and the Upper Hook Latch 176 and Lower Hook Latch 177, even during the controlled movement of the Upper Hook Latch 176 and Lower Hook Latch 177, as the Fish Hook(s) 170 are inserted into the Fish Hook Release 171 and/or when the Electromagnet 175 is energized to release the Fish Hook(s) 170 from the Fish Hook Release 171. Additionally, water seals (not illustrated) on or around the Pivot Point 178 in FIG. 17 may also be included, to ensure no water or moisture intrudes upon the Electromagnet 175 or Hook Release Interface 172, around the Pivot Point 178.

Other mechanical and/or electrical release mechanisms are possible than described above, to facilitate the release of the Fish Hook(s) 170 from the Fish Hook Release 171 and Intelligent Fishing Lure 174. Alternative methods of providing a water tight seal are also possible, other than described above. Additionally, the orientation of the Fish Hook(s) 170 relative to the Fish Hook Release 171 and/or the Intelligent Fishing Lure 174 are only illustrated for convenience, and can be oriented in any such direction to one another to facilitate release of the Fish Hook(s) 170 and/or catching fish.

As an alternative to the command to release the Fish Hook(s) 170 being initiated by the fisherman or fisherwoman, the Controller 173 in the Intelligent Fishing Lure 174 of FIG. 16 could automatically initiate a signal to the Fish Hook Release 171 in FIG. 16 which then initiates a signal to the Hook Release Interface 172 (and in turn, the Electromagnet 175) in FIG. 17 to release the Hook(s) 170, if predefined conditions are established. Some such predefined conditions could include tension on the Fiber Optic Fishing Line 102 or the acceleration or non-movement of the Intelligent Fishing Lure 174, or any other defined conditions, as detected by a so enabled Sensor(s) 184 within the Intelligent Fishing Lure 174.

It should be appreciated that numerous other Fish Hook Release implementations and/or orientations could be realized rather than just the one described above, that achieve the same result, which is to release the Hook(s) 170 from the Intelligent Fishing Lure 174 as so desired manually by the fisherman or fisherwoman, or determined automatically by the Intelligent Fishing System, or both.

Additional control signal commands can be sent from the Intelligent Fishing Rod/Reel 101, 125 or 140 to the Intelligent Fishing Lure 103, 124 or 174. One such additional control signal command could be used to alter the intensity of the illumination source 109.

FIG. 18 describes an alternative use of the technology included in the Intelligent Fishing System. In this alternative embodiment, the Intelligent Kite Monitor System 185, the Intelligent Fishing Lure (now indicated as the Intelligent Kite Monitor 186) is attached to a Kite 187 instead of a fishing hook, and deployed in the air instead of on or under water. The Intelligent Kite Monitor 186 is attached to any Kite 187 as indicated, with Mountings 188 on both the Intelligent Kite Monitor 186 and Kite 187, and optional Kite Connector 189. The Camera(s) 190 in the Intelligent Kite Monitor 186 may need to be repositioned relative to the Intelligent Fishing Lure, to provide a better visual perspective from the air, versus on or underwater. The same basic functionality is still provided by this alternative embodiment, such as visual indications and/or other Sensor(s) 191 information present at or around the Kite 187, and provided via the Fiber Optic Kite Line 192. The Intelligent Kite Monitor 186 serves as a remote device, and interfaces to the same or similar Intelligent Fishing Rod/Reel 101 detailed in FIG. 3, to process and display the information received from the Intelligent Kite Monitor 186, via the Fiber Optic Kite Line 192 (in lieu of the Fiber Optic Fishing Line 102 indicated in FIG. 3), as well as deploy and spool back the Fiber Optic Kite Line 192. The Fiber Optic Kite Line 192 is the same or similar to the Fiber Optic Fishing Line 102 (or Electrical Fishing Line 123). All other variations described previously as part of the Intelligent Fishing System 100 are possible in the Intelligent Kite Monitor System 185.

The same technology of the Intelligent Fishing System can also be implemented without the Fish Hook(s) 170 detailed in FIG. 2, 5, 16 or 17 of the Intelligent Fishing Lure 103, to provide on or underwater monitoring, for a wide array of alternative applications. These applications could include on or underwater surveillance, treasure hunting, locating debris from missing airplanes, boats, ordinances, items or individuals, underwater mapping, locating and/or repair of cables, conduits, piping or drilling rigs, underwater hobbyists, releasing objects, etc. As with the Intelligent Kite Monitor 186, the camera(s) in this modified Intelligent Fishing Lure (without Fish Hook(s)) might need to be repositioned to provide a better view downward.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A fishing system:
a fishing rod comprising a reel, the reel comprising at least a portion of a fiber optic cable;
a first device connected at or near a first end of the fiber optic cable, the first device comprising a controller and at least one camera;
a fiber optic receiver located at or near the fishing rod, the fiber optic receiver coupled to a second end the fiber optic cable and configured to receive optical signals from the first device through the fiber optic cable; and
a processor operably coupled to the fiber optic receiver and to a display.

2. The system of claim 1 further comprising a strain relief mechanism.

3. The system of claim 2 wherein the strain relief mechanism is located within the first device.

4. The system of claim 2 wherein the strain relief mechanism comprises a spring or an epoxy resin.

5. The system of claim 1 wherein the fiber optic receiver comprises a fiber optic diode and a receiver.

6. The system of claim 5 wherein the fiber optic diode is within a strain relief mechanism.

7. The system of claim 1 wherein the first device comprises an illumination source.

8. The system of claim 1 wherein the first device is a fishing lure.

9. The system of claim 1 wherein the first device comprises at least one sensor for measuring at least one of temperature, salinity, and depth.

10. The system of claim 1 wherein the at least one camera records at least one real-time image viewable on the display.

11. The system of claim 1 wherein the display is separate from a housing containing the fiber optic receiver.

12. The system of claim 1 wherein the fiber optic receiver is a transceiver, and the first device is further configured to receive control signals from the transceiver.

13. The system of claim 12 wherein the first device comprises a fish hook release mechanism, and the control signal is a command to the first device to activate the fish hook release mechanism.

14. The system of claim 13 wherein the fish hook release mechanism comprises an electromagnet.

15. The system of claim 12 wherein the first device comprises an illumination source, and the control signal is a command to alter an intensity of the illumination source.

16. The system of claim 1 wherein the coupling of the fiber optic receiver to the processor is not hardwired.

17. The system of claim 1 wherein the processor and display form part of a mobile device.

18. The system of claim 1 wherein the processor is configured to process data received by the receiver to determine the probability of catching a fish at a current location, wherein the data received by the receiver includes at least one of data from the camera, data from a sensor.

19. The system of claim 18 wherein the processor further processes data originating from other fisherman in the determination of the probability of catching the fish at the current location.

20. A monitoring system comprising;
a reel comprising at least a portion of a fiber optic cable;
a remote device connected at or near a first end of the fiber optic cable, the remote device comprising a controller and at least one camera;
a fiber optic receiver coupled to a second end of the fiber optic cable and configured to receive optical signals from the remote device through the fiber optic cable; and
a processor operably coupled to the fiber optic receiver and to a display.
